(19) United States
(12) Patent Application Publication
(10) Pub. No.: US 2026/0299084 A1
(43) Pub. Date: Oct. 1, 2026

(54) SEMICONDUCTOR DEVICE

(71) Applicants: Renesas Electronics Corporation, Tokyo (JP); Carea Corporation, Toyama (JP)

(72) Inventor: Yuji MOTODA, Tokyo (JP)

(21) Appl. No.: 19/545,426

(22) Filed: Feb. 20, 2026

Related U.S. Application Data
(60) Provisional application No. 63/777,762, filed on Mar. 26, 2025.

(30) Foreign Application Priority Data
May 23, 2025 (JP) 2025-086476

(51) Int. Cl. G01S 7/35; G01S 13/32

(52) U.S. Cl. CPC G01S 7/356; G01S 13/32

(57) ABSTRACT

A semiconductor device is provided that includes a first memory storing a program, and a CPU configured to process an input signal in accordance with the program, wherein the CPU performs (a) processing of obtaining respective intensities of respective points of a frequency spectrum obtained by performing Fourier transform on a radar signal outside, input from (b) processing of unwrapping phase components of the respective points of the frequency spectrum and calculating variance to obtain respective variations of phase fluctuation of the respective points of the frequency spectrum, and (c) processing of determining that a human is present at a distance corresponding to a position of a frequency spectrum at which, among the respective points of the frequency spectrum, a respective intensity exceeds a first threshold and a respective variation of phase fluctuation exceeds a second threshold.

### CROSS-REFERENCE TO RELATED APPLICATIONS

The disclosures of U.S. Patent Provisional Application No. 63/777,762 filed on Mar. 26, 2025 and Japanese Patent Application No. 2025-086476 filed on May 23, 2025 including the specification, drawings and abstract are incorporated herein by reference in their entirety.

### BACKGROUND

The present disclosure relates to a semiconductor device.

There are disclosed techniques listed below. [Patent Document 1] Japanese Unexamined Patent Application Publication No. 2019-196995

Patent Document 1 discloses a radar device that is capable of calculating distance with high accuracy using a simple method.

### SUMMARY

However, in order to meet market demands to be described later, it has been necessary to improve accuracy in detecting a human. Accordingly, an object of the present disclosure is to provide a semiconductor device having improved human detection accuracy.

Other problems and novel features will become apparent from the description of the present specification and the accompanying drawings.

According to one embodiment, a semiconductor device is provided that performs processing of determining that a human is present at a distance corresponding to a position of a frequency spectrum at which an intensity of the frequency spectrum exceeds a first threshold and a variance of the frequency spectrum exceeds a second threshold.

According to the one embodiment, a semiconductor device having improved human detection accuracy is provided.

### BRIEF DESCRIPTION OF THE DRAWINGS

FIG. 1 is a diagram illustrating a monitoring system to which the present disclosure is applied.

FIG. 2 is a first diagram illustrating a principle of a radar according to the present disclosure.

FIG. 3 is a second diagram illustrating the principle of the radar according to the present disclosure.

FIG. 4 is a third diagram illustrating the principle of the radar according to the present disclosure.

FIG. 5 is a fourth diagram illustrating the principle of the radar according to the present disclosure.

FIG. 6 is a fifth diagram illustrating the principle of the radar according to the present disclosure.

FIG. 7 is a diagram illustrating a distance measurement example obtained by an experiment.

FIG. 8 is a sixth diagram illustrating the principle of the radar according to the present disclosure.

FIG. 9 is a seventh diagram illustrating the principle of the radar according to the present disclosure.

FIG. 10 is an eighth diagram illustrating the principle of the radar according to the present disclosure.

FIG. 11 is a ninth diagram illustrating the principle of the radar according to the present disclosure.

FIG. 12 is a tenth diagram illustrating the principle of the radar according to the present disclosure.

FIG. 13 is a diagram illustrating a vibration measurement example obtained by an experiment.

FIG. 14 is a block diagram illustrating an overall configuration of a semiconductor device according to the present disclosure.

FIG. 15 is a diagram illustrating a detailed configuration of the semiconductor device according to the present disclosure.

FIG. 16 is a processing flow diagram of a related semiconductor device.

FIG. 17 is a diagram illustrating an example of a phase signal and a histogram of the phase signal obtained when a human and a stationary target are measured using the semiconductor device according to the present disclosure.

FIG. 18 is a diagram illustrating an example of a phase signal and a variance of the phase signal obtained when a human and a stationary target are measured using the semiconductor device according to the present disclosure.

FIG. 19 is a diagram illustrating a verification environment of the semiconductor device according to the present disclosure.

FIG. 20 is a diagram illustrating measurement results of a power spectrum of the phase signal and a variance of phase fluctuation in the verification environment of FIG. 19.

FIG. 21 is a diagram illustrating a phase signal, a histogram of the phase signal, and a variance obtained by measuring a stationary target, a human, and a space using the semiconductor device according the to present disclosure.

FIG. 22 is a diagram illustrating a phase signal and power of the phase signal obtained by measuring a stationary target, a human, and a space using the semiconductor device according to the present disclosure.

FIG. 23 is a diagram illustrating an example of detecting a human by performing an AND operation on power and variance of the phase signal using the semiconductor device according to the present disclosure.

FIG. 24 is a diagram illustrating an example of detecting a human, a stationary object, and a space by performing an AND operation on power and variance of the phase signal using the semiconductor device according to the present disclosure.

FIG. 25 is a processing flow diagram of the semiconductor device according to the present disclosure.

FIG. 26 is a diagram illustrating processing results of the semiconductor device according to the present disclosure.

FIG. 27 is a diagram illustrating first sample processing of the semiconductor device according to the present disclosure.

FIG. 28 is a diagram illustrating second sample processing of the semiconductor device according to the present disclosure.

FIG. 29 is a diagram illustrating first sample processing of the semiconductor device according to the present disclosure.

FIG. 30 is a diagram illustrating third sample processing of the semiconductor device according to the present disclosure.

### DETAILED DESCRIPTION

For clarification of the description, the following partially omitted and description and drawings are simplified as appropriate. In addition, each element illustrated in the drawings as a functional block that performs various processing can be configured, for example, by a Central Processing Unit (CPU), a memory, and other circuits in terms of hardware, and can be implemented, in terms of software, by programs loaded into the memory. Accordingly, these functional blocks can be implemented by hardware, software operating on hardware, or a combination thereof. In addition, in the respective drawings, the same elements are denoted by the same reference numerals, and duplicate descriptions are omitted as appropriate.

The semiconductor device of the present disclosure is formed using a semiconductor such as silicon, germanium, or carbon. The semiconductor exhibits conductivity by addition of boron, phosphorus, arsenic, or the like. The semiconductor device constitutes various electronic circuits using such conductivity.

### Description of Monitoring System According to First Embodiment

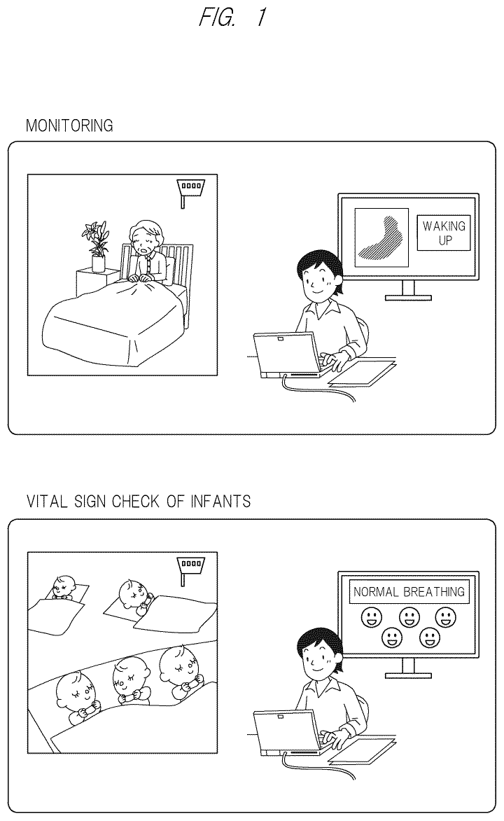

FIG. 1 is a diagram illustrating a monitoring system to which the present disclosure is applied. A monitoring system according to the embodiment will be described with reference to FIG. 1.

There is a need to reduce a burden on a care worker or a childcare worker against a background of a declining birthrate, an aging population, and a shortage of labor. For example, as illustrated in an upper diagram of FIG. 1, it is desirable to monitor a position and a posture of a person requiring care in real time in a nursing care facility. Also, as illustrated in a lower diagram of FIG. 1, it is desirable to monitor a breathing condition of a child in real time in a childcare facility. It is preferable that vital signs of a plurality of persons be able to be checked simultaneously.

As sensors usable for monitoring, a camera, Light Detection And Ranging (Lidar), and contact sensors such as a wristwatch-type sensor are conceivable, and examples used in practice exist. However, there are also problems.

A camera has a privacy problem in that a feeling of resistance caused by being watched in daily life cannot be eliminated. In addition, a camera requires light. A camera cannot perform monitoring in a dark place, such as during sleep. An infrared camera has a privacy problem.

Lidar is still expensive. A contact sensor is not worn willingly or is forgotten to be worn. In order to solve these problems, it is proposed to construct a monitoring system using radar.

### Description of Principle of Radar According to First Embodiment

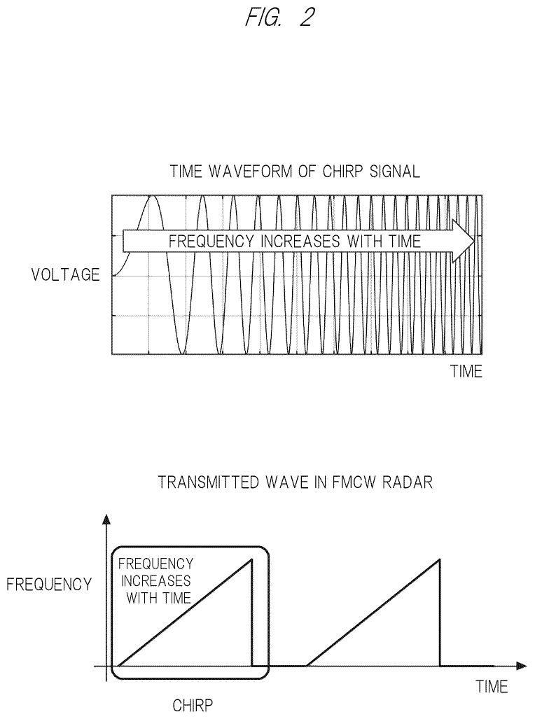

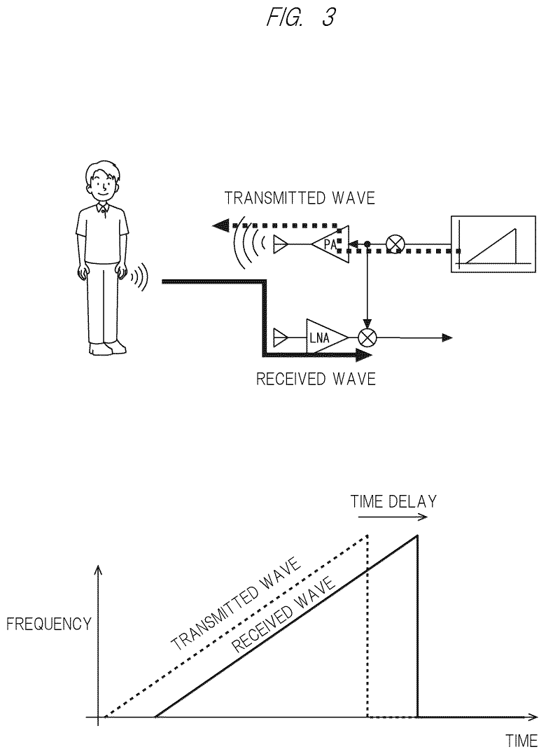

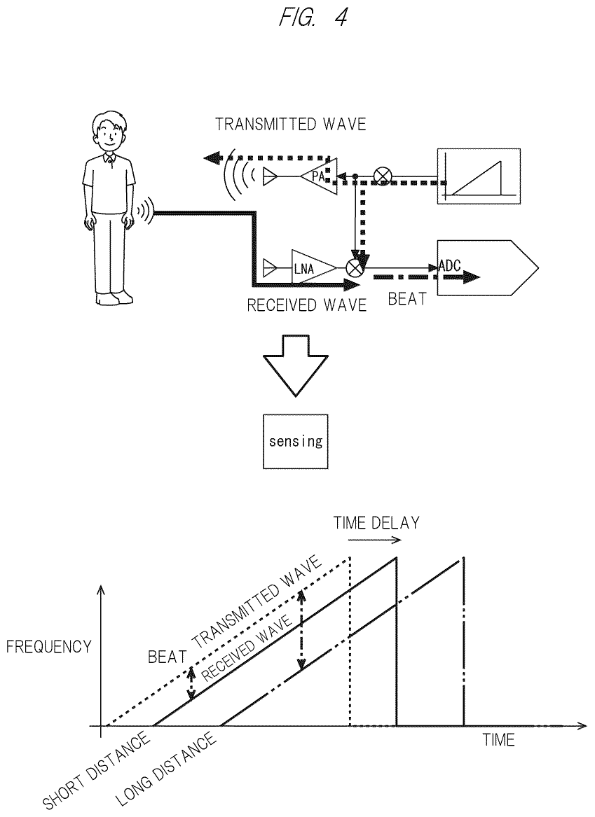

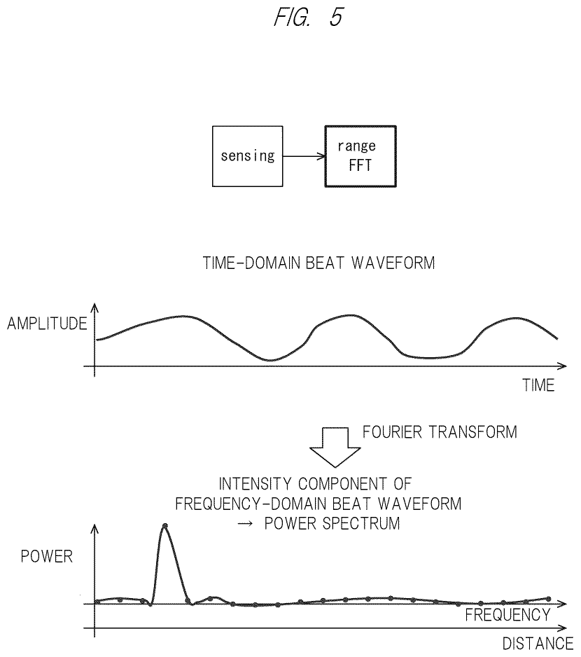

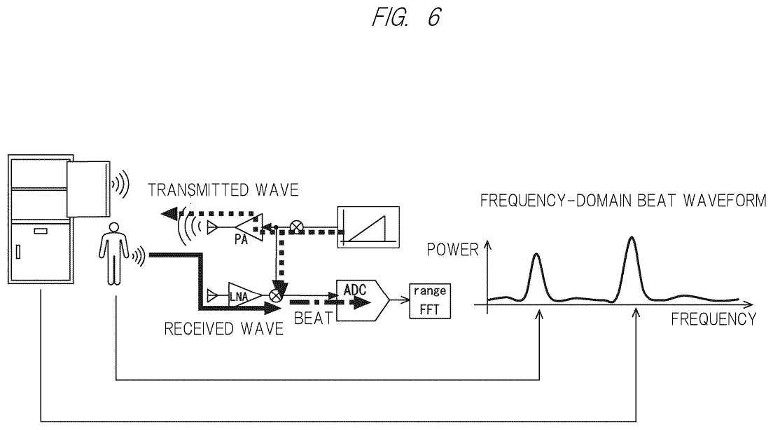

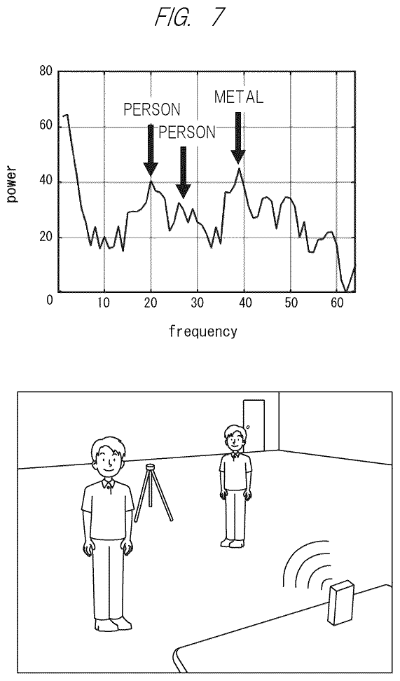

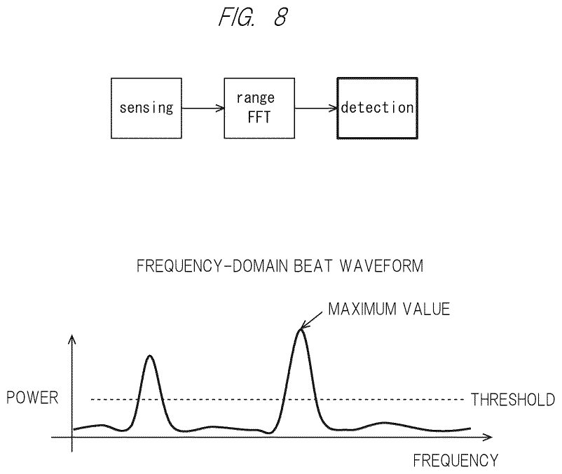

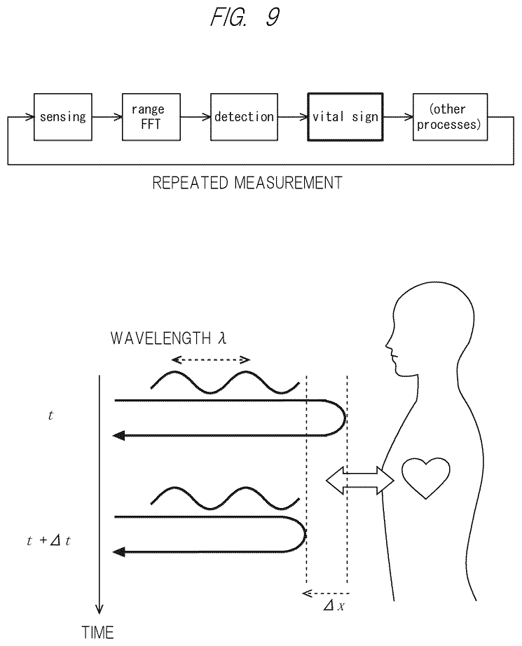

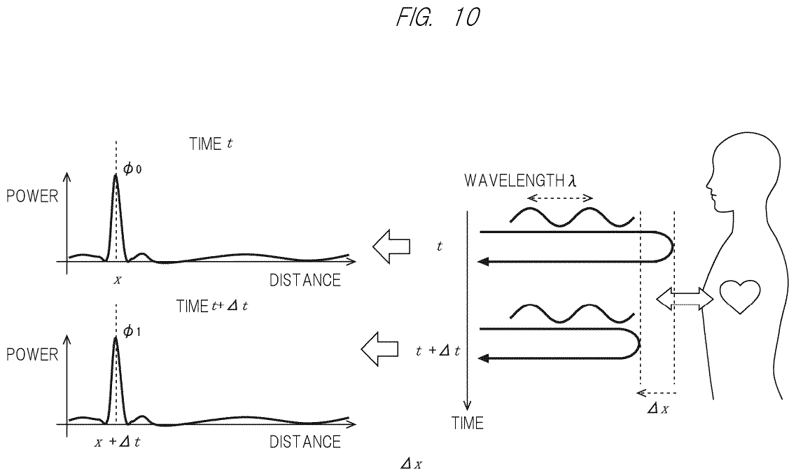

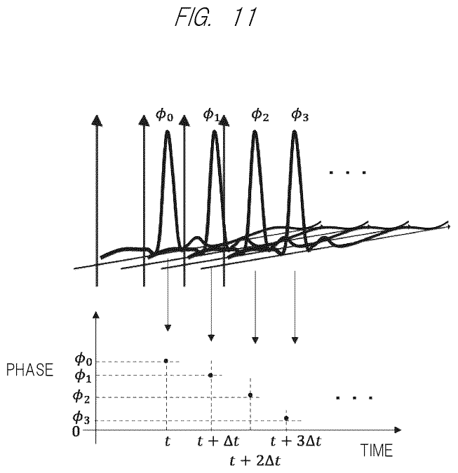

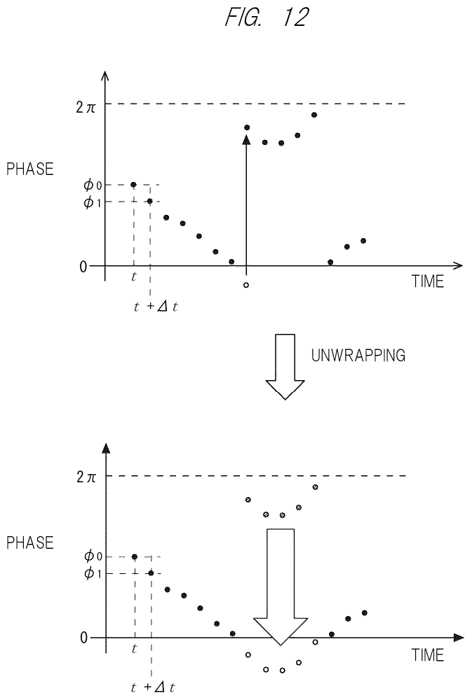

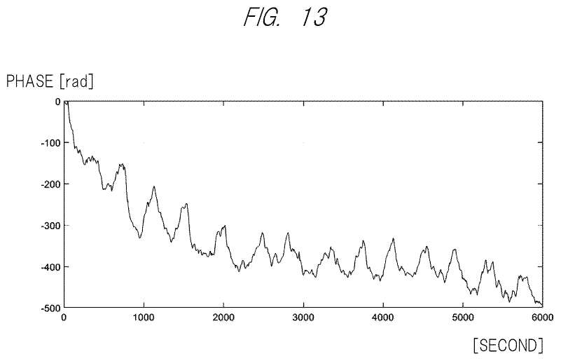

FIG. 2 is a first diagram illustrating a principle of radar according to the present disclosure. FIG. 3 is a second diagram illustrating a principle of radar according to the present disclosure. FIG. 4 is a third diagram illustrating a principle of radar according to the present disclosure. FIG. 5 is a fourth diagram illustrating a principle of radar according to the present disclosure. FIG. 6 is a fifth diagram illustrating a principle of radar according to the present disclosure. FIG. 7 is a diagram illustrating a distance measurement example by experiment. FIG. 8 is a sixth diagram illustrating a principle of radar according to the present disclosure. FIG. 9 is a seventh diagram illustrating a principle of radar according to the present disclosure. FIG. 10 is an eighth diagram illustrating a principle of radar according to the present disclosure. FIG. 11 is a ninth diagram illustrating a principle of radar according to the present disclosure. FIG. 12 is a tenth diagram illustrating a principle of radar according to the present disclosure. FIG. 13 is a diagram illustrating a vibration measurement example by experiment. A principle of radar according to a first embodiment will be described with reference to FIGS. 2 to 13.

There are several derivatives of radar depending on a radio wave transmission method. Here, focus is placed on a Frequency Modulated Continuous Wave (FMCW) radar which is currently a mainstream type of radar.

In an FMCW radar, a continuous wave modulated so that a frequency increases with time is transmitted. This is referred to as a chirp by analogy with birdsong. A chirp waveform has a shape as illustrated in an upper diagram of FIG. 2. However, because the waveform is complicated, representation in which a vertical axis represents frequency is generally performed as illustrated in a lower diagram of FIG. 2.

As illustrated in an upper diagram of FIG. 3, when a transmitted wave hits an object such as a person, the transmitted wave is reflected, and the radar receives the reflected wave as a received wave. As illustrated in a lower diagram of FIG. 3, the received wave is a chirp wave having the same shape as the transmitted wave, but a time delay occurs because a radio wave travels back and forth between the radar and the object.

As illustrated in an upper diagram of FIG. 4, when two waveforms having different frequencies are synthesized, a sum component and a difference component of the frequencies appear as indicated by Expression (1). The difference component is referred to as a beat. Hereinafter, a process from generation of a transmitted wave illustrated in an uppermost diagram of FIG. 4 to A/D conversion of a beat generated is collectively represented as a sensing block.

$$\begin{matrix}[ Expression 1 ] & \\ cos αcosβ = \frac{1}{2} \{ cos ( α + β ) + cos ( α - β ) \} & ( 1 )\end{matrix}$$

As illustrated in a lower diagram of FIG. 4, a frequency of a beat becomes higher as a time delay becomes larger, that is, as a distance to an object becomes longer, and it becomes lower as the distance to the object becomes shorter. Therefore, a distance to the object can be measured by analyzing the frequency of the beat. As illustrated in the upper diagram of FIG. 4, a signal is digitized by an Analog Digital Converter (ADC) for subsequent processing.

In order to analyze a frequency of a beat as illustrated in an upper diagram of FIG. 5, Fourier transform is generally performed. In an implementation, a Fast Fourier Transform (FFT) is generally used, and is referred to as range FFT because a distance (range) is calculated.

As an output of Fourier transform, a sequence of complex numbers called a frequency spectrum is obtained. As illustrated in a lower diagram of FIG. 5, a plot of an intensity component of each point of the frequency spectrum is called a power spectrum.

As a characteristic of a power spectrum, a peak appears in a frequency domain corresponding to a distance to an object. In other words, a horizontal axis in the frequency domain can be regarded as both frequency and distance.

As illustrated in FIG. 6, an output of range FFT has a plurality of peaks standing in bins corresponding to respective distances when there are a plurality of objects at different distances, such as a person and a refrigerator. Further, power varies depending on a size, a material, or a distance of an object.

FIG. 7 illustrates results of measuring a person and a metal object located farther than the person by using a radar. Although the metal object has only a size of about several centimeters and is disposed at a farthest position, a highest peak appears for the metal object. Since radio waves of the radar attenuate in proportion to a fourth power of distance, it can be understood that a signal from the metal object is large. Further, a plurality of other peaks also appear. These peaks are considered to be caused by reflection from a floor or a ceiling, or by multipath of radio waves returning after hitting a plurality of objects.

As illustrated in an upper diagram of FIG. 8, detection of an object is considered based on measurement by range FFT. If an object can be regarded as a single object, detection of the object can be obtained, for example, by calculating a maximum value. As illustrated in a lower diagram of FIG. 8, when a plurality of objects are assumed, detection can be obtained by determining whether a value exceeds a threshold.

As illustrated in an upper diagram of FIG. 9, acquisition of biological information (vital sign) is considered. As illustrated in a lower diagram of FIG. 9, vibration such as human breathing is a periodic positional change. Therefore, for a detected object, it is sufficient to repeat subsequent measurements (referred to as frames) a plurality of times to track a variation thereof.

However, with the distance measurement method described so far, an accuracy is at most on an order of several centimeters, which is insufficient for minute vibrations on an order of millimeters such as human breathing. In addition, in the above-described distance measurement method, accuracy and maximum detection distance have a trade-off relationship, and therefore accuracy cannot be significantly increased also from that viewpoint. Therefore, another method is required.

Since a radio wave having a wavelength λ is a wave, the radio wave has a phase component. As illustrated in the lower diagram of FIG. 9, when a position of an object changes by Δx, a phase change Δφ can be expressed as Expression (2).

$$\begin{matrix}[ Expression 2 ] & \\ Δφ = \frac{4 π Δ x}{λ} & ( 2 )\end{matrix}$$

Δx is doubled to 2Δx in consideration of a round trip. Therefore, if a phase change Δφ is obtained, Δx can also be obtained.

The phase is included in a calculation result of Fourier transform. Each output value of the Fourier transform is expressed in a form of aₖ+bₖi, and power is expressed by Expression (3).

$$\begin{matrix}[ Expression 3 ] & \\ pk = \sqrt{{a}_{k}^{2} + {b}_{k}^{2}} & ( 3 )\end{matrix}$$

The phase is obtained by atan 2(bₖ,aₖ).

As illustrated in FIG. 10, since a bin of a peak of range FFT does not change for human breathing, it is sufficient to track a phase of a bin corresponding to a position of a person in range FFT.

As illustrated in FIG. 11, vibration can be measured by arranging phase signals acquired in each frame with a vertical axis representing phase and a horizontal axis representing time.

By repeating the operation illustrated in FIG. 11, minute vibration can be captured. However, as illustrated in an upper diagram of FIG. 12, phase has a property of returning to zero at 21 (360°) in principle. Therefore, as illustrated in a lower diagram of FIG. 12, a correct waveform can be restored by processing referred to as unwrapping, in which an offset corresponding to phase wrapping is applied.

FIG. 13 illustrates measurement results of vital signs of a human body. A large variation having a period of about 400 frames captures variation due to breathing. Fine jagged portions are considered to be due to heartbeats.

### Description of Semiconductor Device According to First Embodiment

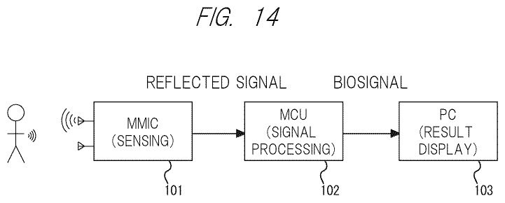

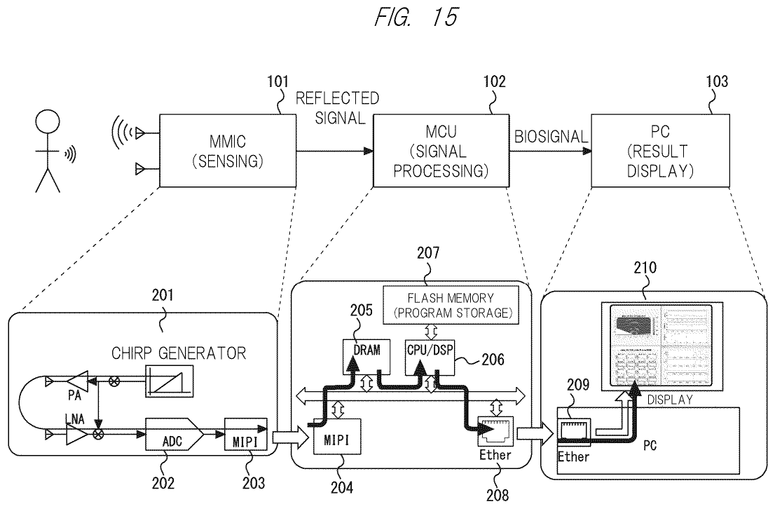

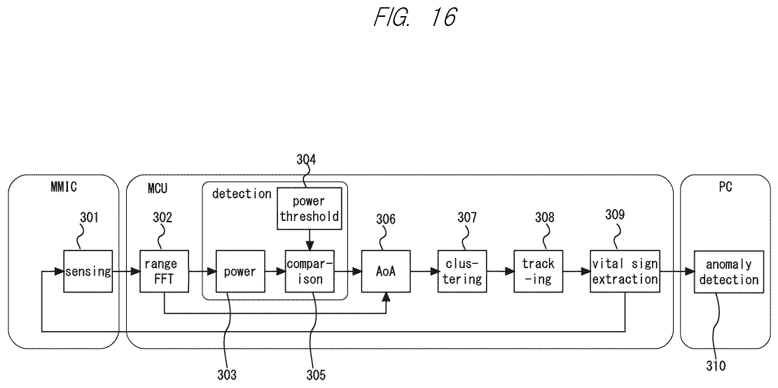

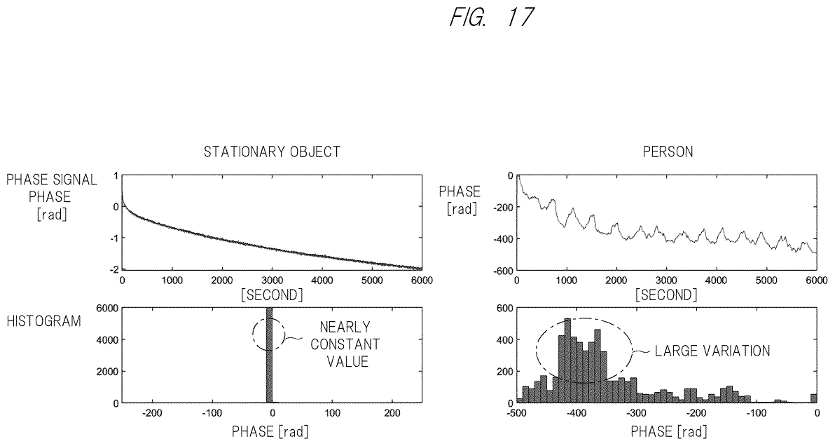

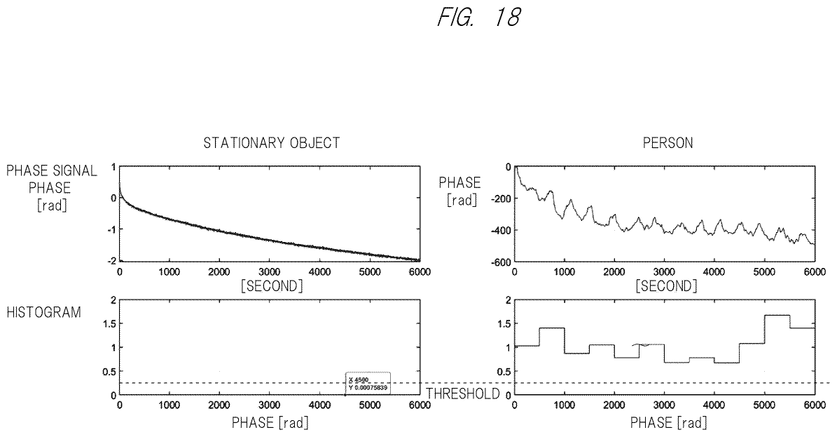

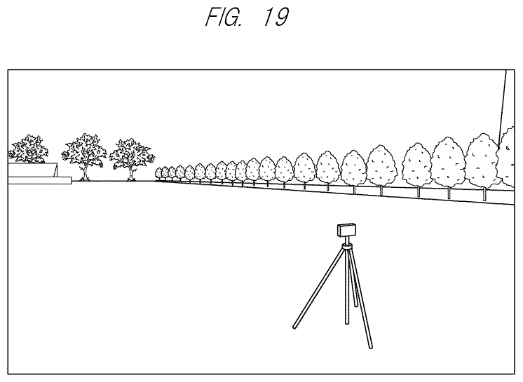

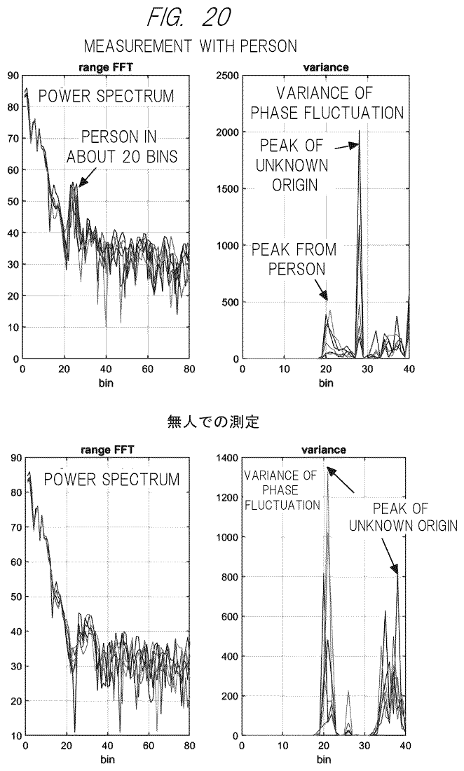

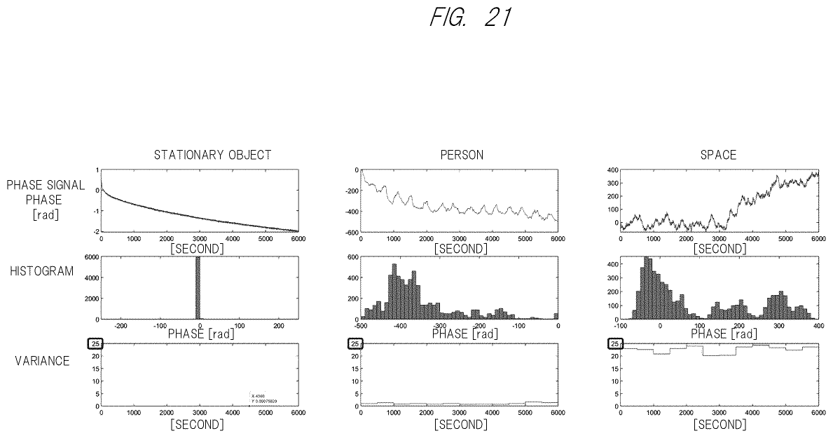

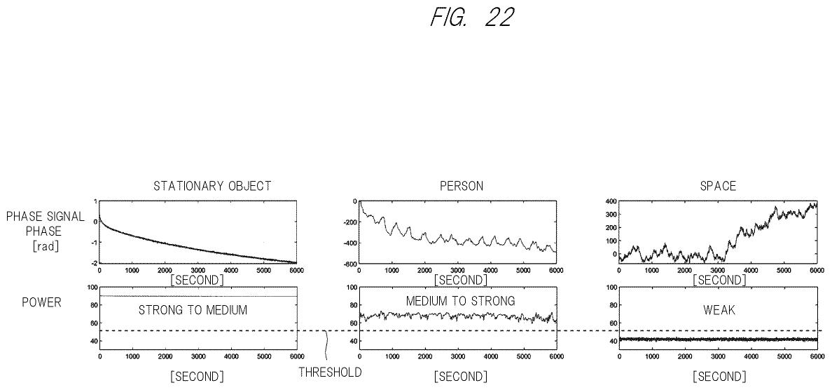

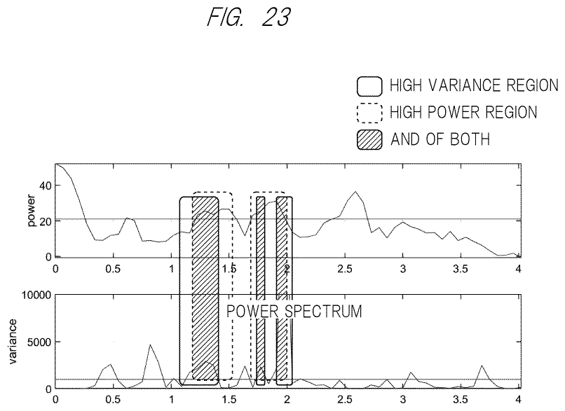

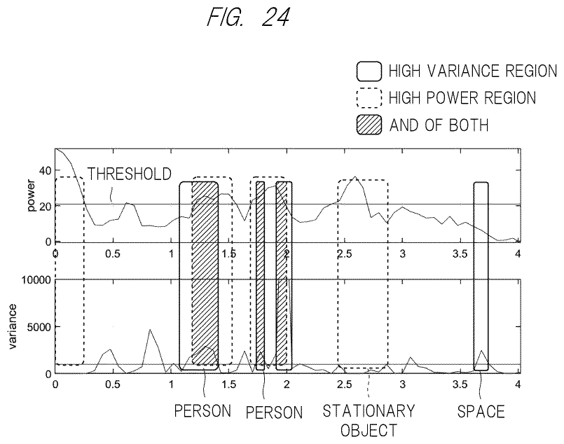

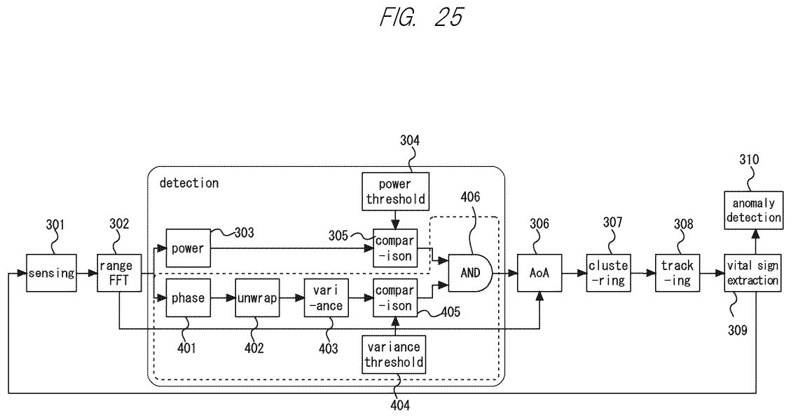

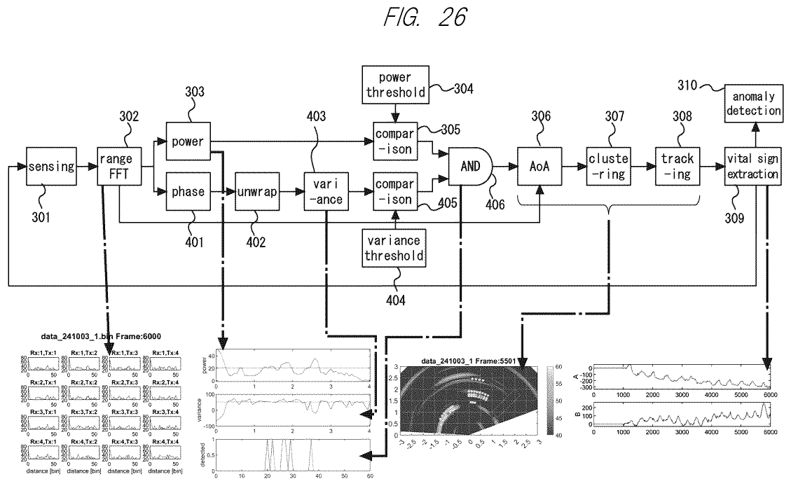

FIG. 14 is a block diagram illustrating an overall configuration of a semiconductor device according to the present disclosure. FIG. 15 is a diagram illustrating a detailed configuration of the semiconductor device according to the present disclosure. FIG. 16 is a processing flow diagram of a related semiconductor device. FIG. 17 is a diagram illustrating an example of a phase signal and a histogram of the phase signal obtained when a person and a stationary object are measured using the semiconductor device according to the present disclosure. FIG. 18 is a diagram illustrating an example of a phase signal and a variance of the phase signal obtained when a person and a stationary object are measured using the semiconductor device according to the present disclosure. FIG. 19 is a diagram illustrating a verification environment of the semiconductor device according to the present disclosure. FIG. 20 is a diagram illustrating measurement results of a power spectrum of a phase signal and a variance of phase variation in the verification environment of FIG. 19. FIG. 21 is a diagram illustrating a phase signal, a histogram of the phase signal, and a variance obtained by measuring a stationary object, a person, and a space using the semiconductor device according to the present disclosure. FIG. 22 is a diagram illustrating a phase signal and power of the phase signal obtained by measuring a stationary object, a person, and a space using the semiconductor device according to the present disclosure. FIG. 23 is a diagram illustrating an example of detecting a person by taking an AND of power and variance of a phase signal using the semiconductor device according to the present disclosure. FIG. 24 is a diagram illustrating an example in which, using the semiconductor device according to the present disclosure, a person, a stationary object, and a space are detected by taking a logical AND of a condition that power of a phase signal exceeds a threshold and a condition that variance exceeds a threshold. FIG. 25 is a processing flow diagram of the semiconductor device according to the present disclosure. FIG. 26 is a diagram illustrating a processing result of the semiconductor device according to the present disclosure. The semiconductor device according to a first embodiment will be described with reference to FIGS. 14 to 26.

As illustrated in FIG. 14, a monitoring system according to the embodiment includes a Monolithic Microwave Integrated Circuit (MMIC) 101 that performs sensing, a Micro Controller Unit (MCU) 102 that performs signal processing, and a Personal Computer (PC) 103 that displays results.

The MMIC 101 transmits a radio wave and receives a radio wave reflected by an object such as a person. The MCU 102 receives a reflected signal from the external MMIC 101 and extracts a biological signal of a person to be measured by applying various signal processing to the reflected signal. The PC 103 displays the biological signal output from the MCU 102.

FIG. 15 is a block diagram illustrating hardware of the monitoring system. As illustrated in FIG. 15, the MMIC 101 includes a chirp generator 201, an Analog Digital Converter (ADC) 202, and an MIPI 203.

The MMIC 101 transmits and receives a radio wave generated using the chirp generator 201. The MMIC 101 digitizes a reflected signal by the ADC 202 and outputs the digitized signal to the MCU 102. The MMIC 101 outputs the digitized signal to the MCU 102 via the Mobile Industry Processor Interface (MIPI) 203.

The MCU 102 receives the reflected signal from the MMIC 101 via an MIPI 204. The MCU 102 stores the reflected signal in a Dynamic Random Access Memory (DRAM) 205. A Central Processing Unit (CPU)/Digital Signal Processor (DSP) 206 performs signal processing on the signal read from the DRAM 205. The CPU/DSP 206 performs processing using a program stored in a flash memory 207. The CPU/DSP 206 extracts a biological signal to be measured and outputs the extracted biological signal to the PC 103 via Ethernet 208.

The PC 103 displays a biological signal output from the MCU 102 and received via Ethernet 209 on a display 210.

FIG. 16 illustrates a processing flow corresponding to each processing block of a related semiconductor device. As illustrated in FIG. 16, the MMIC 101 includes sensing 301. The MCU 102 includes range FFT 302, power 303, power threshold 304, comparison 305, AoA 306, clustering 307, tracking 308, and vital sign extraction 309. The PC 103 includes anomaly detection 310.

The sensing 301 transmits and receives a radar signal, performs A/D conversion on a received wave, and outputs the received wave. The range FFT 302 performs frequency analysis on the received wave from the sensing 301. The power 303 extracts a power component of an output of Fourier transform.

The comparison 305 compares an input value with a threshold (the power threshold 304) and determines magnitude. The power threshold 304 is also referred to as a first threshold. Processing from the power 303 to the comparison 305 corresponds to detection described in the principle.

The AoA 306 calculates an angle of arrival using an output of the range FFT 302 corresponding to an object determined by the detection, and outputs a point cloud indicating a position of the object. The clustering 307 groups the point cloud and calculates coordinates of a person to be tracked. The tracking 308 compares the coordinates obtained by the clustering 307 with previous coordinates of a person and calculates which tracking target the coordinates should be associated with. The vital sign extraction 309 extracts biological information of the tracking target.

The anomaly detection checks 310 whether the biological information of the tracking target is normal or not, and issues a warning when the biological information is abnormal.

As described with reference to FIG. 7, when determination is performed based on power, a metal object or a large object is more easily detected than a person. In a living environment, there are many objects including metal or large objects, such as furniture or electrical appliances. However, only a person is intended to be a measurement target, and metal objects or large objects are to be excluded from targets.

Accordingly, the inventor considered that a person could be distinguished from a stationary object by comparing phase signals, because a phase signal of a person constantly varies due to vital activity, whereas a phase signal of a stationary object remains at a constant value without variation. As illustrated in a left diagram of FIG. 17, when values of a phase signal are converted into a histogram, a stationary object has phase signal values that take an almost constant value. As illustrated in a right diagram of FIG. 17, a histogram of a phase signal of person widely varies. In this manner, a variation in values of the phase signal greatly differs between a stationary object and a person.

As an evaluation index of variation, there is a statistical quantity referred to as variance. Variance is a square of a standard deviation of data or a random variable. A variance s² of data x₁, x₂, . . . , xₙ is expressed by Expression (4).

$$\begin{matrix}[ Expression 4 ] & \\ {s}^{2} = \frac{1}{n} {\sum }_{i = 1}^{n} {( {x}_{i} - \overline{x} )}^{2} & ( 4 )\end{matrix}$$

As illustrated in FIG. 18, when variance was calculated every 500 frames (5 seconds) for a stationary object and a person, a remarkable difference was observed. For example, a person and a stationary object can be distinguished by a dotted line.

Accordingly, as illustrated in FIG. 19, the inventor performed measurement on the ground in order to eliminate influence of a surrounding environment.

As illustrated in an upper diagram of FIG. 20, in a measurement result obtained in the presence of a person, it can be seen from a power spectrum that a person is present in about 20 bins, and a peak derived from the person appears in variance. However, an unexplained peak also appears at a position where a person should not be present. As illustrated in a lower diagram of FIG. 20, in a measurement result obtained in the absence of a person, no peak appears in the power spectrum, but two unexplained peaks appear in variance. Thus, strong variance was observed even under a condition in which no person was present.

Since an empty space does not reflect radio waves unlike a stationary object, noise is observed. As illustrated in a right diagram of FIG. 21, since noise causes phase to vary randomly, variation of phase can become large. As a result, it is considered that results such as those illustrated in FIG. 20 were obtained. When a middle diagram and the right diagram of FIG. 21 are compared, distinction between a person and an empty space cannot be made when viewed in terms of variance.

In an empty space, phase variation varies, but power was small. Therefore, as illustrated in FIG. 22, the inventor found that a person and a space can be distinguished by applying a threshold to power.

As illustrated in FIG. 23, by defining a point at which both power and variance exceed respective thresholds as a position of presence of a person, a stationary object and an empty space can be appropriately excluded, and only a person can be extracted.

As illustrated in FIG. 24, presence or absence of an object is determined based on a threshold of a power spectrum. The power spectrum is obtained by performing Fourier transform on a radar signal and calculating intensity of each frequency spectrum. Further, presence or absence of an object is determined based on a threshold of a spectrum of variation of phase variation. The spectrum of variation of phase variation is obtained by unwrapping a phase component of each frequency spectrum output by Fourier transform. Whether a living body is present or not is determined depending on whether results of both presence/absence determinations are satisfied.

As illustrated in FIG. 25, a processing flow corresponding to each processing block of the semiconductor device according to the first embodiment is illustrated. The detection further includes phase 401, unwrap 402, variance 403, variance threshold 404, comparison 405, and AND 406, in addition to those of the related semiconductor device.

The phase 401 extracts a phase component of an output of Fourier transform. The unwrap 402 unwraps the phase component. The variance 403 calculates variance of the unwrapped phase component. The comparison 405 compares an input value with a threshold (the variance threshold 404) and determines magnitude. The variance threshold 404 is also referred to as a second threshold. The AND 406 takes an AND of an input value of power and an input value of variance.

FIG. 26 illustrates visualization of outputs at respective blocks. Power at each distance is obtained by the range FFT 302. Power in a certain direction is obtained by the power 303. Variance in a certain direction is obtained by the variance 403. An AND of power and variance is taken by the AND 406. Presence or absence of an object in each direction can be visualized by the AoA 306, the clustering 307, and the tracking 308. Biological information such as heartbeats and breathing is obtained by the vital sign extraction 309.

With the above configuration, a semiconductor device with improved human detection accuracy is provided. By taking an AND of determination based on a power spectrum and determination based on variance, a stationary object and an empty space can be excluded. As a result, only a person can be detected.

### Description of Semiconductor Device According to Second Embodiment

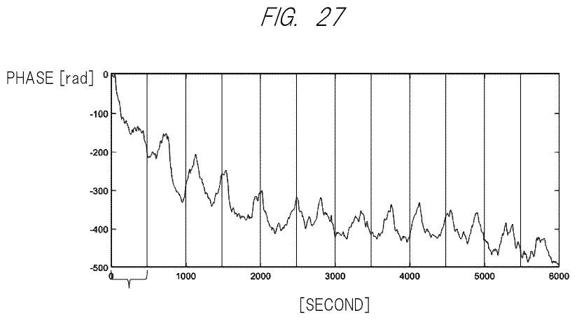

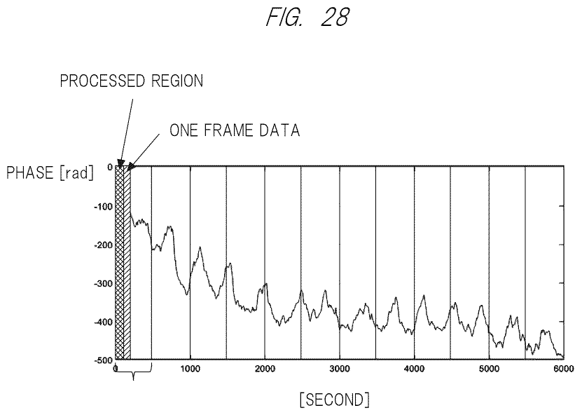

FIG. 27 is a diagram illustrating a first sample processing of a semiconductor device according to the present disclosure. FIG. 28 is a diagram illustrating a second sample processing of the semiconductor device according to the present disclosure. A semiconductor device according to a second embodiment will be described with reference to FIGS. 27 and 28.

Since variance is a statistical quantity, variance is calculated from a plurality of samples. As illustrated in FIG. 27, in the first embodiment, variance is calculated from 500 samples (corresponding to 5 seconds). This number is determined by including a certain margin with respect to one cycle of breathing so that variance can be measured stably, and therefore it is difficult to reduce the number. However, at this stage, since coordinates of an object cannot be specified, it is necessary to hold 500 samples for all bins in an entire range. The number of samples is not limited to 500 and may be a predetermined value. When the number of range bins is 128 and a data type is single precision floating point (4 bytes), 4×128×500=250 [kB] is required. This size is not negligible for an MCU used for radar.

As a method for solving the above problem, an existing sequential calculation algorithm is used. As illustrated in FIG. 28, when a sequential calculation algorithm referred to as Welford's online algorithm is used, it is sufficient to hold data of only one sample.

### Description of Semiconductor Device According to Third Embodiment

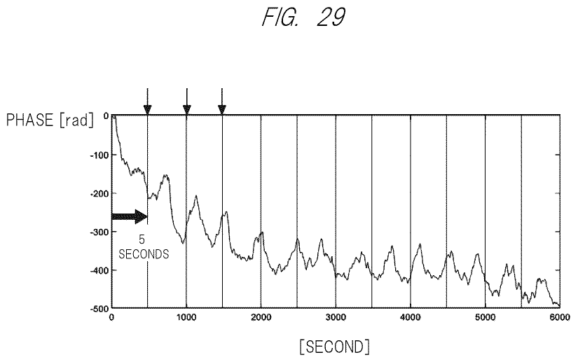

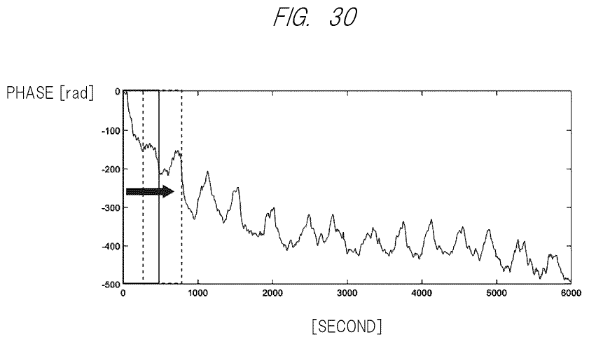

FIG. 29 is a diagram illustrating a first sample processing of a semiconductor device according to the present disclosure. FIG. 30 is a diagram illustrating a third sample processing of the semiconductor device according to the present disclosure. A semiconductor device according to a third embodiment will be described with reference to FIGS. 29 and 30.

As a problem common to the first and second embodiments, there is a problem that an update cycle of values becomes long. As illustrated in FIG. 29, a value of variance is determined at an end of each sample range. Therefore, if a person moves during that period, tracking cannot be performed.

As illustrated in FIG. 30, the above problem can be solved by using moving variance from the range indicated by the solid line to the range indicated by the dotted line. Note that the present disclosure is not limited to the above-described embodiments, and various modifications can be made without departing from the spirit thereof. For example, although detection of a human has been described, detection of an animal may be performed instead.

What is claimed is:

1. A semiconductor device comprising:
a memory storing a program; and
a CPU configured to process an input signal in accordance with the program,
wherein the CPU performs
(a) processing of obtaining respective intensities of respective points of a frequency spectrum obtained by performing Fourier transform on a radar signal input from outside,
(b) processing of unwrapping phase components of the respective points of the frequency spectrum and calculating variance to obtain respective variations of phase fluctuation of the respective points of the frequency spectrum, and
(c) processing of determining that a human is present at a distance corresponding to a position of a frequency spectrum at which, among the respective points of the frequency spectrum, a respective intensity exceeds a first threshold and a respective variation of phase fluctuation exceeds a second threshold.

2. The semiconductor device according to claim 1,
wherein the variance is calculated by holding a predetermined number of samples for all bins over an entire range.

3. The semiconductor device according to claim 1,
the variance is calculated by holding data of one sample using a sequential calculation algorithm.

4. The semiconductor device according to claim 1,
wherein the variance is calculated using moving variance.

5. The semiconductor device according to claim 1,
wherein it is determined that a stationary object is present at a distance corresponding to a position of a frequency spectrum at which the intensity exceeds the first threshold and the variation of phase fluctuation does not exceed the second threshold.

6. The semiconductor device according to claim 5,
wherein it is determined that a space is present at a distance corresponding to a position of a frequency spectrum at which the intensity does not exceed the first threshold and the variation of phase fluctuation exceeds the second threshold.
